(19) United States
(12) Patent Application Publication
(10) Pub. No.: US 2024/0177060 A1
(43) Pub. Date: May 30, 2024

(54) LEARNING DEVICE, LEARNING METHOD AND RECORDING MEDIUM

(71) Applicant: NEC Corporation, Tokyo (JP)

(72) Inventor: Akira TANIMOTO, Tokyo (JP)

(73) Assignee: NEC Corporation, Tokyo (JP)

(21) Appl. No.: 18/389,273

(22) Filed: Nov. 14, 2023

(30) Foreign Application Priority Data
Nov. 18, 2022 (JP) 2022-184674

(51) Int. Cl. G06N 20/00

(52) U.S. Cl. CPC G06N 20/00

(57) ABSTRACT

There is proposed a technique of artificial intelligence (AI) which learns a model for causal inference by using an appropriate loss function. In a learning device, the acquisition means acquires learning data including an explanatory variable, an action, and information of outcome of the action. The learning means learns a model for performing causal inference, using the learning data, based on a loss function partially including a nuisance model which is an estimation object not necessary as a final output. The loss function is defined to pessimistically estimate a loss with respect to uncertainty of the nuisance model by using a worst value within a range in which the nuisance model is more certain than a predetermined value.

### TECHNICAL FIELD

The present disclosure relates to causal inference.

### BACKGROUND ART

There is known causal inference to estimate a causal relationship between data based on an input data and an output data. Patent Document 1 describes a technique for estimating a causal relationship in a machine learning system.

### PRECEDING TECHNICAL REFERENCE

### Patent Document

Patent Document 1: Japanese Patent Application Laid-Open under No. 2019-194849

### SUMMARY

One object of the present disclosure is to propose a method of learning a model used for causal inference using an appropriate loss function.

According to an example aspect of the present invention, there is provided a learning device comprising:
an acquisition means configured to acquire learning data including an explanatory variable, an action, and information of outcome of the action; and
a learning means configured to learn a model for performing causal inference, using the learning data, based on a loss function partially including a nuisance model which is an estimation object not necessary as a final output,
wherein the loss function is defined to pessimistically estimate a loss with respect to uncertainty of the nuisance model by using a worst value within a range in which the nuisance model is more certain than a predetermined value.

According to another example aspect of the present invention, there is provided a learning method comprising:
acquiring learning data including an explanatory variable, an action, and information of outcome of the action; and
learning a model for performing causal inference, using the learning data, based on a loss function partially including a nuisance model which is an estimation object not necessary as a final output,
wherein the loss function is defined to pessimistically estimate a loss with respect to uncertainty of the nuisance model by using a worst value within a range in which the nuisance model is more certain than a predetermined value.

According to still another example aspect of the present invention, there is provided a recording medium recording a program, the program causing a computer to execute processing comprising:
acquiring learning data including an explanatory variable, an action, and information of outcome of the action; and
learning a model for performing causal inference, using the learning data, based on a loss function partially including a nuisance model which is an estimation object not necessary as a final output,
wherein the loss function is defined to pessimistically estimate a loss with respect to uncertainty of the nuisance model by using a worst value within a range in which the nuisance model is more certain than a predetermined value.

According to the present disclosure, it becomes possible to learn a model used for causal inference using an appropriate loss function.

### BRIEF DESCRIPTION OF THE DRAWINGS

FIG. 1 shows an application example of causal inference.

FIG. 2 is a block diagram showing a hardware configuration of a learning device according to a first example embodiment.

FIG. 3 is a block diagram showing a functional configuration of a learning device according to the first example embodiment.

FIG. 4 is a flowchart of learning processing by the learning device.

FIG. 5 is a block diagram showing a functional configuration of a learning device according to a second example embodiment.

FIG. 6 is a flowchart of processing executed by the learning device according to the second example embodiment.

### EXAMPLE EMBODIMENTS

Preferred example embodiments of the present disclosure will be described with reference to the accompanying drawings.

### Basic Description

### [Causal Inference]

In recent years, there has been proposed causal inference, which is a technique to infer causal relationships among data. Inference by supervised learning basically assumes that correct answers for all facts have been prepared. Cross-entropy is known as a loss typically used in supervised learning. The cross entropy is given as the sum of the entropy between the predicted value and the correct answer for all the alternatives (classes) to be predicted. Therefore, in supervised learning, there is also prepared a correct answer to the counterfact, “What if I made this prediction?”

In contrast, when causal inference is used for decision making problems, the results of all the alternatives are generally unknown. In other words, we cannot know the outcomes of actions that were not actually taken (we call this “counterfacts”). This is also referred to as partial observation or bandit feedback. Therefore, the problem in using causal inference for decision making problems is that the outcomes for counterfacts are missing and that the missing is not completely random but biased by background factors (also called “confounding factors”).

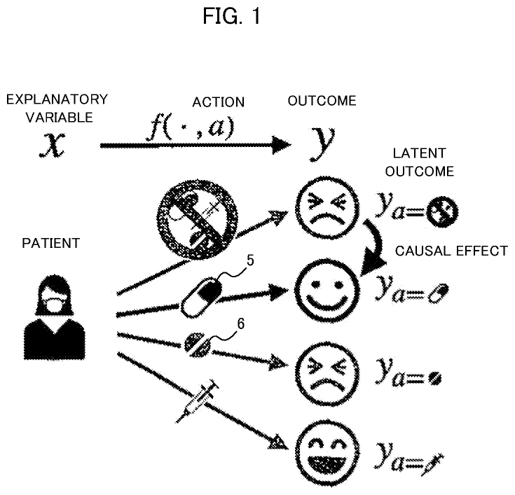

Now, as shown in FIG. 1, we consider performing some treatment for a patient. In this case, the outcome y is obtained by taking some action a for the explanatory variable x. Incidentally, the explanatory variable x is an attribute of the patient such as the age or gender of the patient, which corresponds to the background factors described above. If a capsule 5 is administered to the patient, the outcome yₐ can be observed. However, it would be counterfactual to administer the tablet 6 or give the injection to this patient, and the outcome yₐ for those treatment cannot be observed. In causal inference, we assume the outcomes for these counterfacts as latent outcomes, but we cannot actually observe them. This is the problem of the lack of counterfacts.

There is also a problem that the lack of counterfacts is not generated perfectly randomly, but is biased by background factors. For example, the probability of lack occurrence for individual counterfacts differs when there are such background factors that the medicine is difficult to be prescribed for young people but easy to be prescribed for elder people.

For example, it is assumed that there is such a background factor that strong medicine is prescribed for elder people because elder people often have underlying disease. In this case, if the patient's prognosis was not good as a result of actually administering a strong medicine, it may be judged in terms of statistics that the prognose was not good because of the strong medicine, even though the fact was that the prognose was not good because there was actually an underlying disease. This is also called pseudo-correlation, and is a problem caused by background factors.

However, if information on explanatory variables x relating to background factors, i.e., what we made decisions based on, is obtained, it is possible to address the above-mentioned problems.

### [Accuracy Index of Causal Inference]

The accuracy index of causal inference can be expressed by the following loss function using mean square error (MSE: Mean Square Error).

$$M S {E}^{u} ( \hat{f} ) := {𝔼}_{x} [ \frac{1}{\vert \vert} {\sum }_{a ∈} {( 𝔼 [ {y}_{a} \vert x ] - \hat{f} ( x , a ) )}^{2} ] = {𝔼}_{x} [ \frac{1}{\vert \vert} {\sum }_{a ∈} \frac{μ ( a \vert x )}{μ ( a \vert x )} {( 𝔼 [ {y}_{a} \vert x ] - \hat{f} ( x , a ) )}^{2} ] = {𝔼}_{x} {𝔼}_{a \sim μ ( a \vert x )} [ \frac{1}{\vert \vert μ ( a \vert x )} {( 𝔼 [ {y}_{a} \vert x ] - \hat{f} ( x , a ) )}^{2} ] \qquad ( 1 )$$

Here, “x” represents an explanatory variable corresponding to a background factor, “a” represents an action, and “f\hat{ }(x,a)” represents a prediction result obtained by a model that predicts an outcome y when the action a is selected in the explanatory variable x. In this specification, for convenience of description, a certain symbol with “\hat{ }” on top of “f” is expressed as “f\hat{ }”, which represents the predicted value or the prediction result. The same applies to other symbols. “A” represents a set of actions. MSE^{u}(f\hat{ }) represents the accuracy of the prediction result by the prediction model f(x,a), and “u” of the MSE^{u} represents the uniform selection of action a from the set A of the actions a. “yₐ” represents the outcome when the action a is selected. “E[yₐ|x]” represents the expected value that the outcome yₐ occurs in the background factor x. “μ(a|x)” represents the conditional probability that the action a is selected in the background factor x. μ(a|x) indicates the decision policy of the decision maker in the past and is also called “propensity score”.

As shown in Formula (1) above, the loss function MSE^{u}(f\hat{ }) of causal inference includes the product of the expected value Eₓ that the background factor x occurs and the expected value E_{a˜μ}(a|x) that the action a is selected under that condition. The the product EₓE_{a˜μ}(a|x) can be obtained as a distribution indicating the probability that the combination of the background factor x and the set A of actions a appears in the past observation data. By inputting the probability distribution of the past data to the expected value in Formula (1) and minimizing the value in the brackets [ ], the accuracy of the inference can be improved. As a loss function, a method of weighting a sample by an inverse of the propensity score μ(a|x) as shown in Formula (1) is taken. Hereinafter, the propensity score μ(a|x) is also referred to as a “weight μ(a|x)”.

It is noted that the result of causal inference may become unstable when the accuracy of the model of the weight μ(a|x) obtained by learning is low or the weight takes an extreme value.

In order to find the weight μ(a|x) to be plugged (substituted) into Formula (1), the model of the weight μ(a|x) is learned by supervised learning. Then, the predicted value μ\hat{ }(a|x) of the weight is obtained by using the learned model and is plugged into Formula (1). In this case, the loss function MSE^{u}(f\hat{ }) is expressed as follows:

$$M S {E}^{u} ( \hat{f} ) == {𝔼}_{x} {𝔼}_{a \sim μ ( a \vert x )} [ \frac{1}{\vert \vert \hat{μ} ( a \vert x )} {( 𝔼 [ {y}_{a} \vert x ] - \hat{f} ( x , a ) )}^{2} ] \qquad ( 2 )$$

In reality, since the expected value E[y|x] cannot be obtained as teaching information, the actual observation data y with noise is used. Nevertheless, since Formula (2) is a squared loss relative to the expected value, it can be decomposed as follows.

(y−\hat{f}(x,a))²=( [symbol] [y|x]−\hat{f}(x,a))²+(y− [symbol] [y|x])² (3)

Since the second term on the right-hand side of Formula (3) indicates noise and its noise variance is a constant independent of the prediction model f\hat{ }, it can be ignored in the evaluation of accuracy.

As described above, in the estimation method of learning the model of weight μ(a|x) to obtain the predicted value μ\hat{ }(|a|x) of the weight, and plugging it into the loss function Formula (2) to learn the prediction model f(x,a) (hereinafter also referred to as “plug-in estimation” or “two-step estimation”), the loss when the actions are uniformly distributed (referred to as “De-biased loss”) can be accurately estimated on the assumption that the number of samples is infinite.

However, in the plug-in estimation described above, there may be an optimistic part, depending on the hypothesis of the prediction model f. The learning using the above loss function is a technique to select the best-looking model by optimization based on the observation data. However, if there is a hypothesis in which the training error is small because the amount of data is small, i.e., a hypothesis showing an optimistic loss, it becomes easier to adopt the hypothesis and the estimation becomes unstable.

Therefore, the present example embodiment makes the evaluation value of the hypothesis (i.e., the prediction model f) not optimistic, i.e., pessimistic, in the learning of the model which performs causal inference (hereinafter, also referred to as “causal inference model”). Specifically, by increasing the loss of the prediction model f, the evaluation of the hypothesis based on the prediction model f is made not too optimistic. In other words, the evaluation of the prediction model f is made not optimistic by avoiding extreme weighting, which may occasionally lead to the existence of good parameters. In addition, the evaluation values of really good prediction model are not reduced too much so that the pessimism level becomes small with optimal parameters. This prevents the estimation by the model from becoming unstable.

### First Example Embodiment

Next, a learning device according to a first example embodiment of the present disclosure will be described.

### [Hardware Configuration]

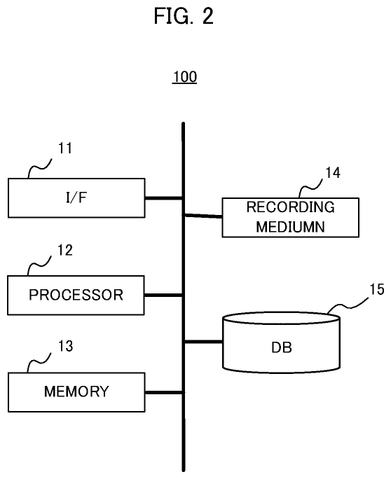

FIG. 2 is a block diagram illustrating a hardware configuration of a learning device 100 according to the first example embodiment. As illustrated, the learning device 100 includes an interface (I/F) 11, a processor 12, a memory 13, a recording medium 14, and a data base (DB) 15.

The I/F 11 inputs and outputs data to and from external devices. Specifically, the learning device 100 acquires information of the explanatory variables related to the causal inference model to be learned through the I/F 11. In addition, the learning device 100 acquires, through the I/F 11, the outcome for a predetermined action as observation data.

The processor 12 is a computer, such as a CPU (Central Processing Unit), and controls the entire learning device 100 by executing a predetermined program. The processor 12 may be a GPU (Graphics Processing Unit) or a FPGA (Field-Programmable Gate Array). The processor 12 executes learning processing to be described later.

The memory 13 may include a ROM (Read Only Memory) and a RAM (Random Access Memory). The memory 13 is also used as a working memory during various processing operations by the processor 12.

The recording medium 14 is a non-volatile and non-transitory recording medium such as a disk-like recording medium, a semiconductor memory, or the like, and is configured to be attachable to and detachable from the learning device 100. The recording medium 14 records various programs executed by the processor 12. When the learning device 100 executes various processing, the program recorded in the recording medium 14 is loaded into the memory 13 and executed by the processor 12.

The DB 15 stores data that the learning device 100 uses for learning. Specifically, the DB 15 stores the explanatory variables of the causal inference model to be learned. For example, in a causal inference model that predicts the effect of medical treatment performed on a patient as shown in FIG. 1, attributes such as age, gender, or the like of the patient are stored as information about the explanatory variables. The DB 15 also stores the observation data of the outcomes obtained in response to the actions actually taken. In addition, the DB 15 stores the accuracy index used to evaluate the accuracy during the learning of the causal inference models, specifically information about the loss function.

### [Functional Configuration]

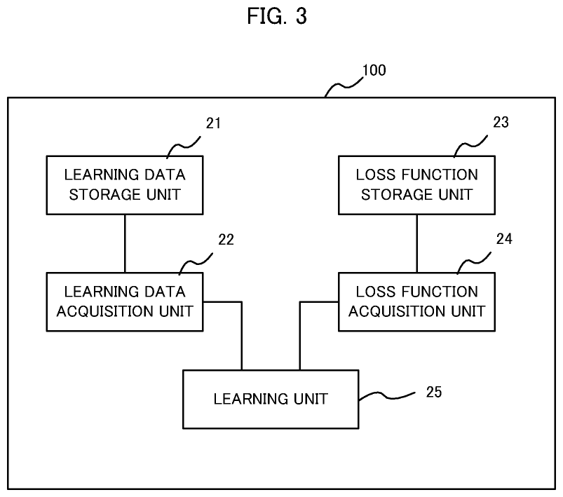

FIG. 3 is a block diagram illustrating the functional configuration of the learning device 100 according to the first example embodiment. The learning device 100 functionally includes a learning data storage unit 21, a learning data acquisition unit 22, a loss function storage unit 23, a loss function acquisition unit 24, and a learning unit 25.

The learning data storage unit 21 stores learning data used for learning of the causal inference model. The learning data storage unit 21 is implemented by the DB 15, for example. The learning data includes the explanatory variables, the actions, and the outcomes of the actions. The outcomes of the actions are obtained as the observation data and are stored in the learning data storage unit 21. The learning data acquisition unit 22 acquires the learning data from the learning data storage unit 21 and outputs them to the learning unit 25.

The loss function storage unit 23 stores a loss function that gives an evaluation index of a causal inference model to be learned. The loss function storage unit 23 is implemented by the memory 13 or the DB 15, for example. While a specific example of the loss function will be described later, the loss function partially including a nuisance model is used in the present example embodiment. A “nuisance model” refers to a model for calculating a predicted value that is not necessary as a final output, but is necessary in the calculation of the loss. The loss function acquisition unit 24 outputs the acquired loss function to the learning unit 25.

The learning unit 25 computes a loss which is an evaluation value of the causal inference model using the learning data and the loss function, and performs learning of the causal inference model so as to minimize the loss. Here, the loss function is defined so that the loss, which is the evaluation value of the causal inference model, does not become optimistic, i.e., becomes pessimistic, as described above. Specifically, the loss function is defined to pessimistically estimate the loss with respect to the uncertainty of the nuisance model by using the worst value within the range in which the nuisance model is more certain than a predetermined value. Using such a loss function, the learning unit 25 performs learning of the causal inference model and outputs the causal inference model obtained by the learning.

### [Learning Processing]

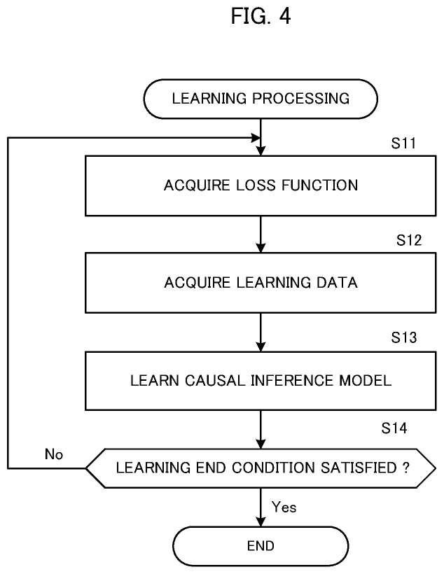

Next, the learning processing performed by the learning device 100 will be described. FIG. 4 is a flowchart of learning processing performed by the learning device 100. This processing is realized by the processor 12 shown in FIG. 2, which executes a program prepared in advance and operates as each element shown in FIG. 3.

First, the loss function acquisition unit 24 acquires a loss function used for learning from the loss function storage unit 23 (step S11). Next, the learning data acquisition unit 22 acquires the learning data from the learning data storage unit 21 (step S12). Next, the learning unit 25 performs learning of the causal inference model using the acquired loss function and the learning data (step S13). Next, the learning unit 25 determines whether or not a predetermined learning end condition is satisfied (step S14). The learning end condition is, for example, that the learning has been performed using all the learning data, the accuracy of the model being learned reaches a predetermined value, and the like. When the learning end condition is not satisfied (step S14: No), the learning unit 25 continues the learning. On the other hand, when the learning end condition is satisfied (step S14: Yes), the learning processing ends.

### EXAMPLES

Hereinafter, examples of the first example embodiment will be described. Incidentally, “objective function” appearing in the following description are all examples of “loss function”.

### First Example

In general, a model for estimating unknown quantity to be substituted into the loss function is called a “nuisance model”. The nuisance model is estimated because it is a necessary parameter for calculation of loss, but it is called a nuisance model in the sense that we do not want to know the parameter itself. The prediction model μ(a|x) of the propensity score in the column of the previous “Basic Description” is an example of a nuisance model.

Let Lᵥ(v) be the objective function related to the nuisance model v. The objective function Lᵥ(v) may be a cross entropy loss, for example, and is not dependent on the parameter θ of the causal inference model to be estimated. In addition, let L(θ;v) be the objective function for the parameter θ of the causal inference model to be estimated. The objective function L(θ;v) is, for example, the mean square error (MSE).

When the loss function includes a nuisance model, generally the nuisance model is learned, and the predicted value by the nuisance model is substituted into the loss function to calculate the loss. This technique is referred to as “plug-in estimation” as described above. In the plug-in estimation, first, the objective function Lᵥ(v) is optimized by learning to obtain the predicted value v\hat{ } of the nuisance model v, and this predicted value v\hat{ } is substituted into the objective function L(θ;v) to obtain a parameter θ\hat{ } which minimizes the objective function L(θ;v\hat{ }).

On the other hand, the learning device according to the first example performs the adversarial simultaneous optimization instead of the usual plug-in estimation, and obtains the parameter θ\hat{ } of the causal inference model by the following formula.

$$\hat{θ} = arg {min}_{θ} {max}_{ν} L ( θ ; ν ) - α {L}_{ν} ( ν ) \qquad ( 4 )$$

During learning, the nuisance model v is basically maximized and the parameter θ is minimized, as shown in Formula (4). Therefore, the nuisance model v is learned to maximize L(θ;v) while minimizing αLᵥ(v). On the other hand, the parameter θ is learned so as to minimize L(θ;v) that the nuisance model v tries to maximize. Thus, the operation to maximize the nuisance model v is constrained by the operation to minimize the parameter θ, and the operation to minimize the parameter θ is constrained by the operation to maximize the nuisance model v. Since the nuisance model v and the parameter θ operate adversarially to optimize both of them simultaneously, we call this technique “adversarial simultaneous optimization”.

Thus, the nuisance model v is maintained in a range in which Lᵥ(v) representing its own certainty computed from the data is appropriate, i.e., in which Lᵥ(v) is more certain than a predetermined value. In addition, the nuisance model v tries to maximize the loss L(θ;v) by maximizing itself while being maintained within a range more certain than the predetermined value controlled by the hyperparameter α. Thus, the loss function L(θ;v)−αLv(v) is defined so as to pessimistically estimate the loss with respect to the uncertainty of the nuisance model by using the worst value within the range in which the nuisance model is more certain than a predetermined value.

Constrained optimization and regularization can be identified under appropriate assumptions about the functional forms of Lᵥ and L. In other words, there is a one-to-one correspondence between the constraint degree of probability and the strength α of regularization, and the solution of the constrained optimization and the solution of the regularized optimization corresponding to each other coincide. Therefore, assuming that the parameter α is later selected by cross-validation or the like, the nuisance model v can be maintained within a range more certain than a predetermined value by the regularization using the parameter α.

### Second Example

The second example is an example embodying the first example, in which the objective function of the nuisance model is used as a weight in the loss function of the causal inference model.

Let Lᵥ(v) be the objective function of the nuisance model v. It is assumed that the objective function Lᵥ(v) does not depend on the parameter θ of the causal inference model to be estimated. In addition, let L(θ;v) be the weighted objective function for the parameter θ of the causal inference model to be estimated, as follows.

$$L ( θ ; ν ) = \frac{1}{N} {\sum }_{i} {ω}^{i} ( ν ) {ℓ}^{i} ( θ ) \qquad ( 5 )$$

This objective function is obtained by multiplying the loss function [symbol] ⁱ(θ) by the output of the nuisance model v as a weight ωⁱ(v). Note that “i” indicates the sample number.

When the adversarial simultaneous optimization according to the present example embodiment is applied as in the first example, the parameter θ of the causal inference model to be estimated is given by the following formula.

$$\hat{θ} = arg {min}_{θ} {max}_{ν} \frac{1}{N} {\sum }_{i} {ω}^{i} ( ν ) {ℓ}^{i} ( θ ) - α {L}_{ν} ( ν ) \qquad ( 6 )$$

For example, the nuisance model v may be the model of the propensity score μ(a|x), and the weight may be ωⁱ=1/μ(aⁱ|xⁱ). Also, the objective function Lᵥ(v) related to the nuisance model may use a discrimination loss, such as cross entropy, which becomes small when the model of the propensity score accurately predicts the action.

In Formula (6), as in Formula (4) in the first example, the nuisance model v is maintained in a range in which Lᵥ(v) representing its own probability computed from the data is appropriate, i.e., in which Lᵥ(v) is more certain than a predetermined value. In addition, the nuisance model v tries to maximize the weighted loss ωⁱ(v)lⁱ(θ) by maximizing itself while being maintained within a range more certain than the predetermined value controlled by the hyperparameter α. Thus, the loss function ωⁱ(v)lⁱ(θ)−αLᵥ(v) is defined so as to pessimistically estimate the loss with respect to the uncertainty of the nuisance model by using the worst value within the range in which the nuisance model is more certain than a predetermined value.

In Formula (6), when the nuisance model v is learned to maximize the weight ωⁱ(v), the weight ωⁱ(v) increases as learning progresses. When the weight becomes extremely large, the substantial data size for the weight becomes small and the estimated variance increases. Therefore, by introducing a term that normalizes the weight, the following formula is obtained.

$$\hat{θ} = arg {min}_{θ} {max}_{ν} {\sum }_{i} \frac{{ω}^{i} ( ν )}{{ω}_{i} ( ν )} {ℓ}^{i} ( θ ) - α {L}_{ν} ( ν ) \qquad ( 7 )$$

Formula (7) normalizes the weight to 1 by multiplying the weight ωⁱ(v) by the normalization term 1/Σᵢωⁱ(v). The technique in Formula (7) can be called the self-normalized version of Formula (6).

### Third Example Embodiment

The third example applies the technique of this example embodiment to the objective variable conversion method. In causal inference, the difference between the outcomes when action a is selected and when it is not selected under a certain background factor x is often estimated as an effect. This is called conditional causal effect (hereinafter also referred to “CATE: Conditional Average Treatment Effect”). The causal effect of taking action a under a certain background factor x is given by the following formula.

τ(x)=f(x,a=1)−f(x,a=0)= [symbol] [yₐ₌₁−yₐ₌₀|x] (8)

However, we cannot give a correct answer to CATE τ(x) in reality because Formula (8) needs the observation data when action a is selected and when action a is not selected.

On the other hand, the objective variable conversion method is based on the idea that the value of CATE τ(x) with noise can be obtained. When the outcome y is replaced with the objective variable z by the objective variable conversion method, the objective variable z after the conversion is given by the following formula.

$${z}^{i} = {y}_{1}^{i} \frac{{a}^{i}}{\hat{μ} ( {x}^{i} )} - {y}_{0}^{i} \frac{( 1 - {a}^{i} )}{1 - \hat{μ} ( {x}^{i} )} \qquad ( 9 )$$

In Formula (9), the second term becomes 0 when the action a is selected, and the first term becomes 0 when the action a is not selected. Therefore, in any case, the objective variable z can be calculated using the actually observed data and the propensity score μ(x). Here, when the predicted value μ\hat{ } of the propensity score μ(x)=μ(a=1|x) is correct, the expected value of the objective variable zⁱ coincides with CATE τ(x). That is, CATE estimation model τ\hat{ }, which is a regression of the objective variable z to the background factor x, can be regarded as the expected value E[yₐ₌₁−yₐ₌₀|x] of Formula (8) with noise, and coincides with the true CATE when the number of samples is infinite. Therefore, CATE estimation model τ\hat{ } can be learned by the regression of the objective variable z to the background factor x.

Specifically, the objective variable z after conversion is replaced by a function of the propensity score μ as follows.

[symbol]

_{μ}ⁱ= [symbol] (aⁱ,y; μ) (10)

Then, we define the CATE estimation model τ\hat{ } as follows by the above-mentioned adversarial simultaneous optimization.

$$\hat{τ} = arg {min}_{τ} {max}_{μ} \frac{1}{N} {\sum }_{i} \{ ℓ ( {z}_{μ ,}^{i} τ ) - α NLL ( μ , ( {x}^{i} , {a}^{i} ) ) \} \qquad ( 11 )$$

Here, NLL (Negative Log Likelihood) is the original loss function for the propensity score μ, such as cross-entropy.

In Formula (11), the propensity score μ is learned to minimize the second term “−αNLL(μ,(xⁱ,aⁱ))” and to maximize the loss function, which is the first term, in curly braces {}. On the other hand, the parameter τ is learned to minimize the loss function l(zⁱμ,τ) which the nuisance model μ tries to maximize. As a result, loss function {l(zⁱμ,τ)−αNLL(μ,(xⁱ,aⁱ))} pessimistically estimates the loss with respect to the uncertainty of the nuisance model by using the worst value in a range in which the nuisance model μ is more certain than a predetermined value.

### Fourth Example

The fourth example is a method for estimating the conditional causal effect CATE as in the third example, but uses a Doubly Robust Learner (hereinafter, also referred to as “DRL”) instead of the objective variable conversion method in the third example.

The conditional causal effect CATE is expressed by Formula (8) described above. Here, in DRL, the latent outcome prediction models f\hat{ }₁, f\hat{ }₀ are learned for the data for each action a∈{0,1}, as follows.

y₁≃\hat{f}₁(x), y₀≃\hat{f}₀(x) (12)

That is, the prediction model f\hat{ }₁(x) which predicts the outcome y₁ when the action a=1, and the prediction model f\hat{ }₀(x) which predicts the outcome y₀ when the action a=0 are learned individually.

Next, using the objective variable conversion method for data for each action and the propensity score μ, the objective variable z_{μ} after conversion is defined as follows.

$${z}_{μ}^{i} = {\hat{f}}_{1} ( {x}^{i} ) - {\hat{f}}_{0} ( {x}^{i} ) + {\overbrace{\frac{{y}_{1}^{i} - {\hat{f}}_{1} ( {x}^{i} )}{μ ( {x}^{i} )}}}^{RESIDUAL} {a}^{i} - {\overbrace{\frac{{y}_{0}^{i} - {\hat{f}}_{0} ( {x}^{i} )}{1 - μ ( {x}^{i} )}}}^{RESIDUAL} ( 1 - {a}^{i} ) \qquad ( 13 )$$

The predicted value f\hat{ }₁(xⁱ) of the prediction model f\hat{ }₁(x) and the predicted value f\hat{ }₀(xⁱ) of the prediction model f\hat{ }₀(x) are plugged into Formula (13).

In Formula (13), first the difference between the predicted value f\hat{ }₁(xⁱ) when action a=1 and the predicted value f\hat{ }₀(x) when action a=0 is calculated. In addition, the residual between the outcome yⁱ₁ and the predicted value f\hat{ }₁(xⁱ) when action a=1 is weighted by the reciprocal of the propensity score μ(xⁱ) and added. further, the residual between the outcome yⁱ₀ and the predicted value f\hat{ }₀(xⁱ) when action a=0 is weighted by the reciprocal of 1−μ(xⁱ) and subtracted. That is, differently from the third example, the predicted value f\hat{ }₁(xⁱ) of the prediction model f\hat{ }₁(x) and the predicted value f\hat{ }₀(xⁱ) of the prediction model f\hat{ }₀(x) individually learned are plugged into the objective variable z_{μ} after conversion.

The objective variable z_{μ} after conversion basically becomes a correct value if the predicted value of the prediction model is correct. Even if the predicted value of the prediction model is incorrect, if the model of the propensity score μ is correct, the residuals are adjusted and the objective variable z_{μ} after conversion becomes a correct value. In this sense, it is called doubly robust.

Using the objective variable z_{μ} after conversion, the model τ of CATE as follows is learned.

$$\hat{τ} = arg {min}_{τ} {max}_{μ} \frac{1}{N} {\sum }_{i} \{ ℓ ( {z}_{μ ,}^{i} τ ) - α NLL ( μ , ( {x}^{i} , {a}^{i} ) ) \} \qquad ( 14 )$$

Formula (14) is similar to Formula (11), and the propensity score μ is learned to minimize the second term “−αNLL(μ,(xⁱ,aⁱ))” and to maximize the loss function, which is the first term, in curly braces {}. On the other hand, the parameter τ is learned to minimize the loss function [symbol] (zⁱμ,τ) which the nuisance model μ tries to maximize. As a result, loss function { [symbol] (zⁱ,μ,τ)−αNLL(μ,(xⁱ,aⁱ))} pessimistically estimates the loss with respect to the uncertainty of the nuisance model by using the worst value in a range in which the nuisance model μ is more certain than a predetermined value.

### Second Example Embodiment

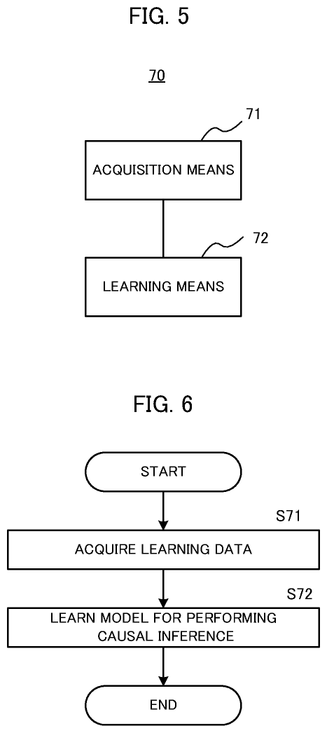

FIG. 5 is a block diagram illustrating a functional configuration of a learning device according to the second example embodiment. As shown, the learning device 70 includes an acquisition means 71 and a learning means 72.

FIG. 6 is a flowchart of processing performed by the learning device according to the second example embodiment. The acquisition means 71 acquires learning data including an explanatory variable, an action, and information of outcome of the action (step S71). The learning means 72 learns a model for performing causal inference, using the learning data, based on a loss function partially including a nuisance model which is an estimation object not necessary as a final output (step S72). Here, the loss function is defined to pessimistically estimate a loss with respect to uncertainty of the nuisance model by using a worst value within a range in which the nuisance model is more certain than a predetermined value.

### Application Field

The causal inference model obtained by the above learning can be applied to various fields. For example, in the medical field, causal inference models can be used to predict the effects of medicine and medical treatment. Specifically, as shown in FIG. 1, the attributes of the patient can be used as explanatory variables, the medical treatment for the patient can be used as an action, the condition of the patient after the medical treatment can be used as an outcome. Also, in the medical field, causal inference models can be applied to prediction of chemical characteristics, optimization of experiments, etc.

Also, in the field of marketing, causal inference models can be applied to estimation of price elasticity and cross elasticity, price optimization and dynamic pricing, demand forecast and inventory optimization considering inventory of other products, and individual product recommendation. Also, in the area of policy and education, causal inference models can be applied to predicting and evaluating policy effects, recommending problems, and so on.

A part or all of the example embodiments described above may also be described as the following supplementary notes, but not limited thereto.

### Supplementary Note 1

A learning device comprising:
an acquisition means configured to acquire learning data including an explanatory variable, an action, and information of outcome of the action; and
a learning means configured to learn a model for performing causal inference, using the learning data, based on a loss function partially including a nuisance model which is an estimation object not necessary as a final output,
wherein the loss function is defined to pessimistically estimate a loss with respect to uncertainty of the nuisance model by using a worst value within a range in which the nuisance model is more certain than a predetermined value.

### Supplementary Note 2

The learning device according to Supplementary note 1, wherein the learning means optimizes the nuisance model and the loss function simultaneously and adversarially.

### Supplementary Note 3

The learning device according to Supplementary note 1, wherein the learning means performs learning using a loss function related to the nuisance model and a loss function related to the model for performing the causal inference.

### Supplementary Note 4

The learning device according to Supplementary note 1, wherein the loss function includes the nuisance model as a weight.

### Supplementary Note 5

The learning device according to Supplementary note 1, wherein the loss function calculates a weighted loss using the nuisance model as a weight for the loss.

### Supplementary Note 6

The learning device according to Supplementary note 1, wherein the loss function includes estimation of conditional causal effects by the model for performing the causal inference.

### Supplementary Note 7

A learning method comprising:
acquiring learning data including an explanatory variable, an action, and information of outcome of the action; and
learning a model for performing causal inference, using the learning data, based on a loss function partially including a nuisance model which is an estimation object not necessary as a final output,
wherein the loss function is defined to pessimistically estimate a loss with respect to uncertainty of the nuisance model by using a worst value within a range in which the nuisance model is more certain than a predetermined value.

### Supplementary Note 8

A recording medium recording a program, the program causing a computer to execute processing comprising:
acquiring learning data including an explanatory variable, an action, and information of outcome of the action; and
learning a model for performing causal inference, using the learning data, based on a loss function partially including a nuisance model which is an estimation object not necessary as a final output,
wherein the loss function is defined to pessimistically estimate a loss with respect to uncertainty of the nuisance model by using a worst value within a range in which the nuisance model is more certain than a predetermined value.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

This application is based upon and claims the benefit of priority from Japanese Patent Application 2022-184674, filed on Nov. 18, 2022, the disclosure of which is incorporated herein in its entirety by reference.

### DESCRIPTION OF SYMBOLS

12 Processor
21 Learning data storage unit
22 Learning data acquisition unit
23 Loss function storage unit
24 Loss function acquisition unit
25 Learning unit

1. A learning device comprising:
a memory configured to store instructions; and
a processor configured to execute the instructions to:
acquire learning data including an explanatory variable, an action, and information of outcome of the action; and
learn a model for performing causal inference, using the learning data, based on a loss function partially including a nuisance model which is an estimation object not necessary as a final output,
wherein the loss function is defined to pessimistically estimate a loss with respect to uncertainty of the nuisance model by using a worst value within a range in which the nuisance model is more certain than a predetermined value.

2. The learning device according to claim 1, wherein the processor optimizes the nuisance model and the loss function simultaneously and adversarially.

3. The learning device according to claim 1, wherein the processor performs learning using a loss function related to the nuisance model and a loss function related to the model for performing the causal inference.

4. The learning device according to claim 1, wherein the loss function includes the nuisance model as a weight.

5. The learning device according to claim 1, wherein the loss function calculates a weighted loss using the nuisance model as a weight for the loss.

6. The learning device according to claim 1, wherein the loss function includes estimation of conditional causal effects by the model for performing the causal inference.

7. A learning method comprising:
acquiring learning data including an explanatory variable, an action, and information of outcome of the action; and
learning a model for performing causal inference, using the learning data, based on a loss function partially including a nuisance model which is an estimation object not necessary as a final output,
wherein the loss function is defined to pessimistically estimate a loss with respect to uncertainty of the nuisance model by using a worst value within a range in which the nuisance model is more certain than a predetermined value.

8. A non-transitory computer-readable recording medium recording a program, the program causing a computer to execute processing comprising:
acquiring learning data including an explanatory variable, an action, and information of outcome of the action; and
learning a model for performing causal inference, using the learning data, based on a loss function partially including a nuisance model which is an estimation object not necessary as a final output,
wherein the loss function is defined to pessimistically estimate a loss with respect to uncertainty of the nuisance model by using a worst value within a range in which the nuisance model is more certain than a predetermined value.
